(19) United States
(12) Patent Application Publication
(10) Pub. No.: US 2022/0222008 A1
(43) Pub. Date: Jul. 14, 2022

(54) METHOD FOR MANAGING FLASH MEMORY MODULE AND ASSOCIATED FLASH MEMORY CONTROLLER AND MEMORY DEVICE

(71) Applicant: Silicon Motion, Inc., Hsinchu County (TW)

(72) Inventors: Tsung-Yao Chiang, Hsinchu County (TW); Jian-Hao Huang, Changhua County (TW)

(21) Appl. No.: 17/149,700

(22) Filed: Jan. 14, 2021

(51) Int. Cl. G06F 3/06

(52) U.S. Cl. CPC G06F 3/0652; G06F 3/064; G06F 3/0679; G06F 3/0608

(57) ABSTRACT

The present invention provides a method for managing a flash memory module, wherein the method comprises the steps of: grouping a plurality of blocks within the flash memory module into a plurality of groups, wherein each group comprises at least two blocks; establishing a valid page table, wherein the valid page table records indexes of the plurality of blocks and corresponding numbers of valid pages, respectively; establishing a group minimum valid page array based on the valid page table; referring to the group minimum valid page array to select a target group having a global minimum valid page, wherein the global minimum valid pages is obtained by selecting a minimum value among the minimum valid pages of the groups; searching the at least two blocks within the target group to determine a target block having the global minimum valid pages; and adding the target block into a garbage collection queue.

### BACKGROUND OF THE INVENTION

### 1. Field of the Invention

The present invention relates to a flash memory controller.

### 2. Description of the Prior Art

In a flash memory module, because data stored in a page of a block cannot be overwritten, when the data is updated by new data, the new data must be stored into another page, and the original data becomes invalid data. Therefore, a number of valid pages within the block will be reduced when the data of the block is updated by the new data stored in page(s) of another block. To effectively use the blocks of the flash memory module, a flash memory controller searches all of the blocks to find one or more blocks having least valid pages, and the flash memory controller performs a garbage collection operation to release these blocks having the least valid pages, that is the flash memory controller moves the valid pages of these blocks to other block(s), then these blocks are erased to become blank block(s).

Because the flash memory controller searches all of the blocks to find the blocks having the least valid pages, if the flash memory module includes many blocks such as one thousand blocks, the search time becomes longer that may degrade system efficiency.

### SUMMARY OF THE INVENTION

It is therefore an objective of the present invention to provide control method of a flash memory module, which groups the blocks in the flash memory module, for the flash memory controller to efficiently find the block(s) having the least valid pages, to solve the above-mentioned problems.

In one embodiment of the present invention, a method for managing a flash memory module comprises the steps of: grouping a plurality of blocks within the flash memory module into a plurality of groups, wherein each group comprises at least two blocks; establishing a valid page table, wherein the valid page table records indexes of the plurality of blocks and corresponding numbers of valid pages, respectively; establishing a group minimum valid page array based on the valid page table, wherein the group minimum valid page array records group indexes and corresponding minimum valid pages, respectively, wherein the minimum valid pages is obtained by selecting a minimum value among the numbers of valid pages of the blocks within the group; referring to the group minimum valid page array to select a target group having a global minimum valid page, wherein the global minimum valid pages is obtained by selecting a minimum value among the minimum valid pages of the groups; searching the at least two blocks within the target group, without searching the blocks within the other groups, to determine a target block having the global minimum valid pages; and adding the target block into a garbage collection queue.

In another one embodiment of the present invention, a flash memory controller having a memory and a microprocessor is disclosed, wherein the memory stores a program code, and the microprocessor executes the program code to access the flash memory module. During operation of the flash memory module, the microprocessor groups a plurality of blocks within the flash memory module into a plurality of groups, wherein each group comprises at least two blocks; the microprocessor establishes a valid page table, wherein the valid page table records indexes of the plurality of blocks and corresponding numbers of valid pages, respectively; the microprocessor establishes a group minimum valid page array based on the valid page table, wherein the group minimum valid page array records group indexes and corresponding minimum valid pages, respectively, wherein the minimum valid pages is obtained by selecting a minimum value among the numbers of valid pages of the blocks within the group; the microprocessor refers to the group minimum valid page array to select a target group having a global minimum valid page, wherein the global minimum valid pages is obtained by selecting a minimum value among the minimum valid pages of the groups; the microprocessor searches the at least two blocks within the target group, without searching the blocks within the other groups, to determine a target block having the global minimum valid pages; and the microprocessor adds the target block into a garbage collection queue.

In another one embodiment of the present invention, a memory device comprising a flash memory module and a flash memory controller is disclosed. In the operation of the memory device, the flash memory controller groups a plurality of blocks within the flash memory module into a plurality of groups, wherein each group comprises at least two blocks; the flash memory controller establishes a valid page table, wherein the valid page table records indexes of the plurality of blocks and corresponding numbers of valid pages, respectively; the flash memory controller establishes a group minimum valid page array based on the valid page table, wherein the group minimum valid page array records group indexes and corresponding minimum valid pages, respectively, wherein the minimum valid pages is obtained by selecting a minimum value among the numbers of valid pages of the blocks within the group; the flash memory controller refers to the group minimum valid page array to select a target group having a global minimum valid page, wherein the global minimum valid pages is obtained by selecting a minimum value among the minimum valid pages of the groups; the flash memory controller searches the at least two blocks within the target group, without searching the blocks within the other groups, to determine a target block having the global minimum valid pages; and the flash memory controller adds the target block into a garbage collection queue.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic device according to an embodiment of the present invention.

FIG. 2 is a diagram of a three-dimensional (3D) NAND flash memory module according to an embodiment of the present invention.

FIG. 3 is a flowchart of a method for managing the flash memory module.

FIG. 4 shows the groups according to one embodiment of the present invention.

FIG. 5 shows a valid page table and a group minimum valid page array according to one embodiment of the present invention.

FIG. 6 is a flowchart of a method for managing the flash memory module according to another embodiment of the present invention.

FIG. 7 shows that different types of blocks are grouped according to one embodiment of the present invention.

### DETAILED DESCRIPTION

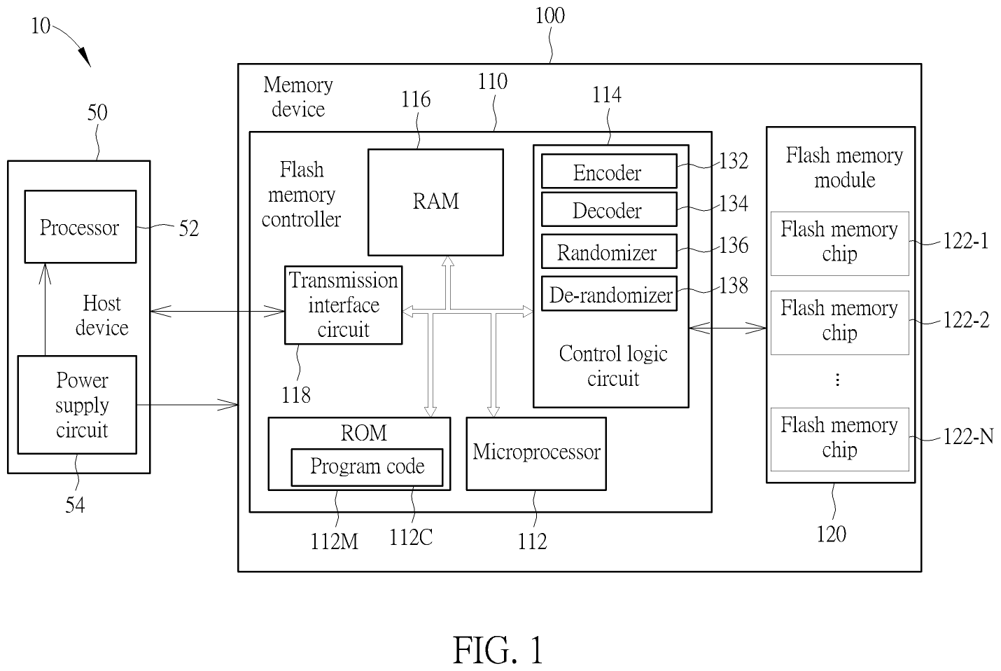

FIG. 1 is a diagram of an electronic device 10 according to an embodiment of the present invention, where the electronic device 10 may comprise a host device 50 and a memory device 100. The host device 50 may comprise at least one processor (e.g. one or more processors) which may be collectively referred to as the processor 52, and may further comprise a power supply circuit 54 coupled to the processor 52. The processor 52 is arranged for controlling operations of the host device 50, and the power supply circuit 54 is arranged for providing power to the processor 52 and the memory device 100, and outputting one or more driving voltages to the memory device 100. The memory device 100 may be arranged for providing the host device 50 with storage space, and obtaining the one or more driving voltages from the host device 50 as power source of the memory device 100. Examples of the host device 50 may include, but are not limited to: a multifunctional mobile phone, a wearable device, a tablet computer, and a personal computer such as a desktop computer and a laptop computer. Examples of the memory device 100 may include, but are not limited to: a solid state drive (SSD), and various types of embedded memory devices such as that conforming to Peripheral Component Interconnect Express (PCIe) specification, etc. According to this embodiment, the memory device 100 may comprise a flash memory controller 110, and may further comprise a flash memory module 120, where the flash controller 110 is arranged to control operations of the memory device 100 and access the flash memory module 120, and the flash memory module 120 is arranged to store information. The flash memory module 120 may comprise at least one flash memory chip such as a plurality of flash memory chips 122-1,122-2, . . . , and 122-N, where “N” may represent a positive integer that is greater than one.

As shown in FIG. 1, the flash memory controller 110 may comprise a processing circuit such as a microprocessor 112, a storage unit such as a read-only memory (ROM) 112M, a control logic circuit 114, a RAM 116, and a transmission interface circuit 118, where the above components may be coupled to one another via a bus. The RAM 116 is implemented by a Static RAM (SRAM), but the present invention is not limited thereto. The RAM 116 may be arranged to provide the memory controller 110 with internal storage space. For example, the RAM 116 may be utilized as a buffer memory for buffering data. In addition, the ROM 112M of this embodiment is arranged to store a program code 112C, and the microprocessor 112 is arranged to execute the program code 112C to control the access of the flash memory module 120. Note that, in some examples, the program code 112C may be stored in the RAM 116 or any type of memory. Further, the control logic circuit 114 may be arranged to control the flash memory module 120, and may comprise an encoder 132, a decoder 134, a randomizer 136, a de-randomizer 138 and other circuits. The transmission interface circuit 118 may conform to a specific communications specification (e.g. Serial Advanced Technology Attachment (Serial ATA, or SATA) specification, Peripheral Component Interconnect (PCI) specification, Peripheral Component Interconnect Express (PCIe) specification, UFS specification, etc.), and may perform communications according to the specific communications specification, for example, perform communications with the host device 50 for the memory device 100, where the host device 50 may comprise the corresponding transmission interface circuit conforming to the specific communications specification, for performing communications with the memory device 100 for the host device 50.

In this embodiment, the host device 50 may transmit host commands and corresponding logical addresses to the memory controller 110 to access the memory device 100. The memory controller 110 receives the host commands and the logical addresses, and translates the host commands into memory operating commands (which may be simply referred to as operating commands), and further controls the flash memory module 120 with the operating commands to perform reading, writing/programing, etc. on memory units (e.g. data pages) having physical addresses within the flash memory module 120, where the physical addresses correspond to the logical addresses. When the flash memory controller 110 perform an erase operation on any flash memory chip 122-n of the plurality of flash memory chips 122-1,122-2, . . . , and 122-N (in which “n” may represent any integer in the interval [1, N]), at least one block of multiple blocks of the flash memory chip 122-n may be erased, where each block of the blocks may comprise multiple pages (e.g. data pages), and an access operation (e.g. reading or writing) may be performed on one or more pages.

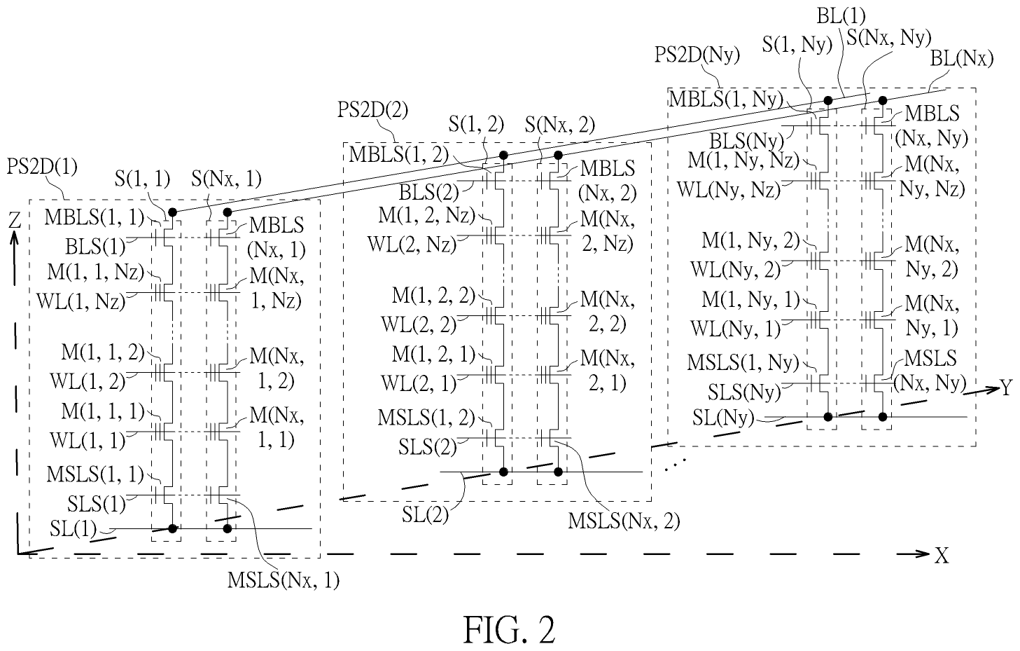

FIG. 2 is a diagram of a three-dimensional (3D) NAND flash memory module according to an embodiment of the present invention. For example, any memory element within the aforementioned at least one of the flash memory chips 122-1, 122-2, . . . , and 122-N, may be implemented based on the 3D NAND flash memory shown in FIG. 2, but the present invention is not limited thereto.

According to this embodiment, the 3D NAND flash memory may comprise a plurality of memory cells arranged in a 3D structure, such as (Nx*Ny*Nz) memory cells {{M(1, 1, 1), . . . , M(Nx, 1, 1)}, {M(1, 2, 1), . . . , M(Nx, 2, 1)}, . . . , {M(1 , Ny, 1), . . . , M(Nx, Ny, 1)}}, {{M(1 , 1, 2), . . . , M(Nx, 1, 2)}, {M(1 , 2, 2), . . . , M(Nx, 2, 2)}, . . . , {M(1, Ny, 2), . . . , M(Nx, Ny, 2)}}, . . . , and {{M(1, 1, Nz), . . . , M(Nx, 1, Nz)}, {M(1, 2, Nz), . . . , M(Nx, 2, Nz)}, . . . , {M(1, Ny, Nz), . . . , M(Nx, Ny, Nz)}} that are respectively arranged in Nz layers perpendicular to the Z-axis and aligned in three directions respectively corresponding to the X-axis, the Y-axis, and the Z-axis, and may further comprise a plurality of selector circuits for selection control, such as (Nx*Ny) upper selector circuits {MBLS(1, 1), . . . , MBLS(Nx, 1)}, {MBLS(1, 2), . . . , MBLS(Nx, 2)}, . . . , and {MBLS(1, Ny), . . . , MBLS(Nx, Ny)} that are arranged in an upper layer above the Nz layers and (Nx*Ny) lower selector circuits {MSLS(1, 1), . . . , MSLS(Nx, 1)}, {MSLS(1, 2), . . . , MSLS(Nx, 2)}, . . . , and {MSLS(1, Ny), . . . , MSLS(Nx, Ny)} that are arranged in a lower layer below the Nz layers. In addition, the 3D NAND flash memory may comprise a plurality of bit lines and a plurality of word lines for access control, such as Nx bit lines BL(1), . . . , and BL(Nx) that are arranged in a top layer above the upper layer and (Ny*Nz) word lines {WL(1 , 1), WL(2, 1), . . . , WL(Ny, 1)}, {WL(1 , 2), WL(2, 2), . . . , WL(Ny, 2)}, . . . , and {WL(1, Nz), WL(2, Nz), . . . , WL(Ny, Nz)} that are respectively arranged in the Nz layers. Additionally, the 3D NAND flash memory may comprise a plurality of selection lines for selection control, such as Ny upper selection lines BLS(1), BLS(2), . . . , and BLS(Ny) that are arranged in the upper layer and Ny lower selection lines SLS(1), SLS(2), . . . , and SLS(Ny) that are arranged in the lower layer, and may further comprise a plurality of source lines for providing reference levels, such as Ny source lines SL(1), SL(2), . . . , and SL(Ny) that are arranged in a bottom layer below the lower layer.

As shown in FIG. 2, the 3D NAND flash memory may be divided into Ny circuit modules PS2D(1), PS2D(2), . . . , and PS2D(Ny) distributed along the Y-axis. For better comprehension, the circuit modules PS2D(1), PS2D(2), . . . , and PS2D(Ny) may have some electrical characteristics similar to that of a planar NAND flash memory having memory cells arranged in a single layer, and therefore may be regarded as pseudo-2D circuit modules, respectively, but the present invention is not limited thereto. In addition, any circuit module PS2D(ny) of the circuit modules PS2D(1), PS2D(2), . . . , and PS2D(Ny) may comprise Nx secondary circuit modules S(1, ny), . . . , and S(Nx, ny), where “ny” may represent any integer in the interval [1, Ny]. For example, the circuit module PS2D(1) may comprise Nx secondary circuit modules S(1, 1), . . . , and S(Nx, 1), the circuit module PS2D(2) may comprise Nx secondary circuit modules S(1, 2), . . . , and S(Nx, 2), . . . , and the circuit module PS2D(Ny) may comprise Nx secondary circuit modules S(1, Ny), . . . , and S(Nx, Ny). In the circuit module PS2D(ny), any secondary circuit module S(nx, ny) of the secondary circuit modules S(1, ny), . . . , and S(Nx, ny) may comprise Nz memory cells M(nx, ny, 1), M(nx, ny, 2), . . . , and M(nx, ny, Nz), and may comprise a set of selector circuits corresponding to the memory cells M(nx, ny, 1), M(nx, ny, 2), . . . , and M(nx, ny, Nz), such as the upper selector circuit MBLS(nx, ny) and the lower selector circuit MSLS(nx, ny), where “nx” may represent any integer in the interval [1, Nx]. The upper selector circuit MBLS(nx, ny) and the lower selector circuit MSLS(nx, ny) and the memory cells M(nx, ny, 1), M(nx, ny, 2), . . . , and M(nx, ny, Nz) may be implemented with transistors. For example, the upper selector circuit MBLS(nx, ny) and the lower selector circuit MSLS(nx, ny) may be implemented with ordinary transistors without any floating gate, and any memory cell M(nx, ny, nz) of the memory cells M(nx, ny, 1), M(nx, ny, 2), . . . , and M(nx, ny, Nz) may be implemented with a floating gate transistor, where “nz” may represent any integer in the interval [1, Nz], but the present invention is not limited thereto. Further, the upper selector circuits MBLS(1, ny), . . . , and MBLS(Nx, ny) in the circuit module PS2D(ny) may perform selection according to the selection signal on the corresponding selection line BLS(ny), and the lower selector circuits MSLS(1, ny), . . . , and MSLS(Nx, ny) in the circuit module PS2D(ny) may perform selection according to the selection signal on the corresponding selection line SLS(ny).

In the flash memory module 120, when the block of any one of the flash memory chips 122-1-122-N serves as a single-level cell (SLC) block, each of the physical pages within the block correspond to one logical page, that is each of the memory cells of the page is configured to store only one bit, wherein one physical page may comprise all of the transistors controlled by a word line(e.g. the memory cells M(1, 1, Nz)-M(Nx, 1, Nz) corresponding to the word line WL(1, Nz) form a physical page). When the block of any one of the flash memory chips 122-1-122-N serves as an multiple-level cell (MLC) block, each of the physical pages within the block correspond to two logical pages, that is each of the memory cells of the page is configured to store two bits. When the block of any one of the flash memory chips 122-1-122-N serves as a triple-level cell (TLC) block, each of the physical pages within the block correspond to three logical pages, that is each of the memory cells of the page is configured to store three bits. When the block of any one of the flash memory chips 122-1-122-N serves as a quad-level cell (QLC) block, each of the physical pages within the block correspond to four logical pages, that is each of the memory cells of the page is configured to store four bits.

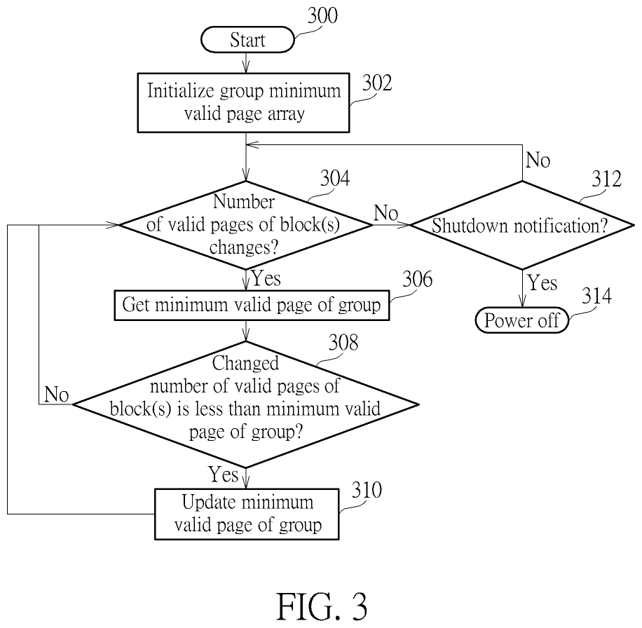

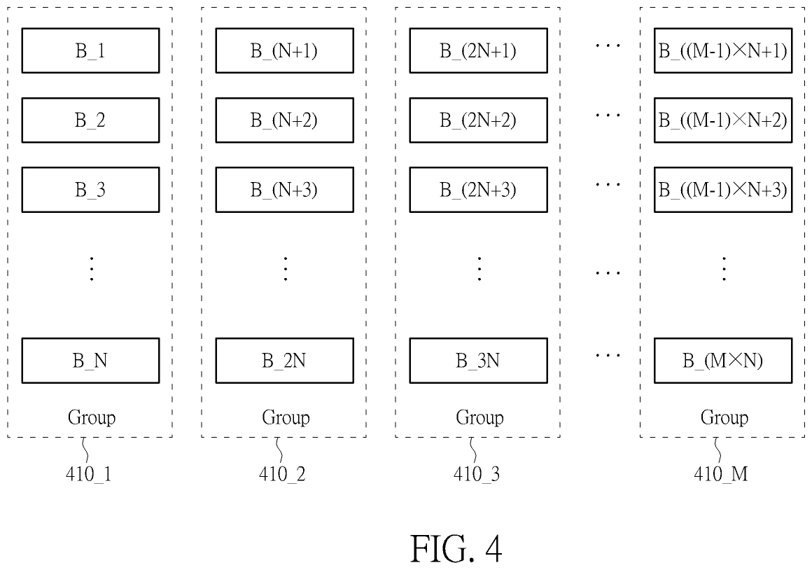

FIG. 3 is a flowchart of a method for managing the flash memory module 120. In Step 300, the flow starts, and the flash memory controller 110 and the flash memory module 120 are powered on from a power-off state. In Step 302, the microprocessor 112 of the flash memory controller 110 starts to establish a group minimum valid page array. Specifically, the blocks within the flash memory module 120 are divided into several groups, and each group comprises many blocks. FIG. 4 shows a plurality of groups 410_1-410_M according to one embodiment of the present invention, wherein the group 410_1 comprises the blocks B_1-B_N, the group 410_2 comprises the blocks B_(N+1)−B_2*N, the group 410_3 comprises the blocks 3*N, . . . , the group 410_M comprises the blocks B_((M−1*N+1))−B_(M*N). In one embodiment, assuming that a number of the blocks needed to be grouped is A, the blocks are divided into \sqrt{A} groups, wherein if \sqrt{A} is not an integer, the number of the groups is a smallest integer larger than \sqrt{A}; and the number of blocks within one group is \sqrt{A}, wherein if \sqrt{A} is not an integer, the number of blocks within one group is a largest integer less than \sqrt{A}.

In a first embodiment of the grouping method, each of the groups has the same number of blocks, and the remaining blocks are not grouped. For example, if there are one thousand blocks, thirty-two groups may be set, each group comprises thirty-one blocks, and the remaining eight blocks are not grouped. In a second embodiment of the grouping method, the groups may have different blocks.

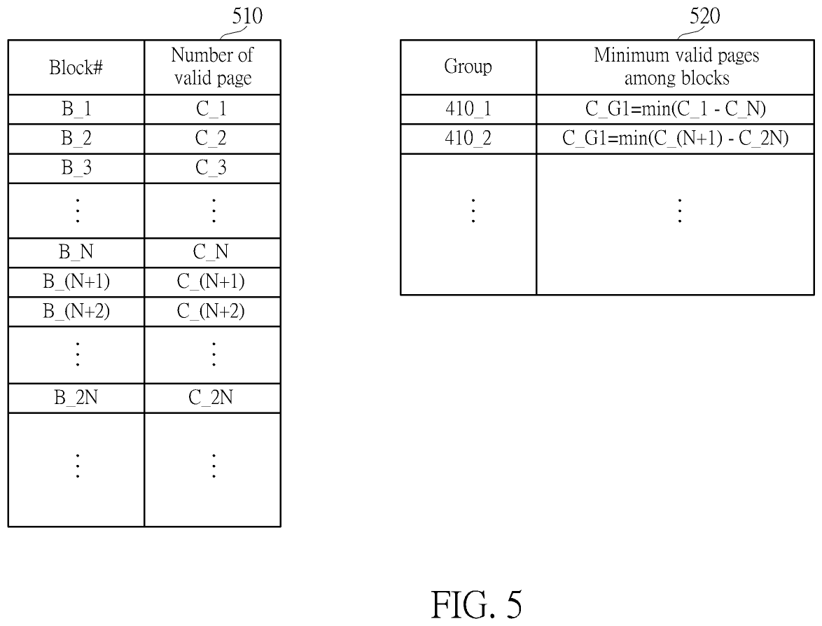

Referring to FIG. 5, the microprocessor 112 establishes a valid page table 510, wherein the valid page table 510 records the block indexes and the corresponding numbers of valid pages, for example, the number of valid pages within the block B_1 is C_1, the number of valid pages within the block B_2 is C_2, the number of valid pages within the block B_3 is C_3, and so on. It is noted that, some of the blocks B_1-B_(M*N) are blank, so the valid page table 510 only records the blocks having data stored therein. The valid page table 510 may be updated if a write operation is performed on the flash memory module 120, for example, if the new data is written into the block B_2, and the new data is used to update the original data stored in the block B_1 (i.e. the new data and the original data have the same logical address), the valid page table 510 is updated by increasing the number C_2 and decreasing the number C_1. In addition, the valid page table 510 may be stored in the RAM 116 or an external dynamic random access memory (DRAM).

Based on the groups 410_1-410_M and the valid page table 510, the microprocessor 112 establishes the group minimum valid page array 520. Specifically, the group minimum valid page array 520 records the group index and corresponding minimum valid pages among the blocks. In detail, the microprocessor 112 refers to the valid page table 510 to obtain the numbers of valid pages C_1-C_N respectively corresponding to the blocks B_1-B_N within the group 410_1, and the microprocessor 112 select a minimum value of the numbers C_1-C_N to be the minimum valid pages C_G1 recorded in the group minimum valid page array 520. For example, if the C_1, C_2, C3, . . . , C_N are 64, 40, 90, . . . , 80, respectively, and the number C_2 may be selected and the group minimum valid page array 520 records the number C_2 as the minimum valid pages C_G1 corresponding to the block 410_1. Similarly, the microprocessor 112 refers to the valid page table 510 to obtain the numbers of valid pages C_(N+1)−C_2*N respectively corresponding to the blocks B_(N+1)−B_2*N within the group 410_2, and the microprocessor 112 select a minimum value of the numbers C_(N+1)−C_2*N to be the minimum valid pages C_G2 recorded in the group minimum valid page array 520. In addition, the group minimum valid page array 520 may be stored in the RAM 116 or the DRAM.

In Step 304, the microprocessor 112 determines if the valid page table 510 is updated and the number of the valid pages of at least one block is changed, if yes, the flow enters Step 306; if not, the flow enters Step 312. The valid page table 510 may be updated if the write operation is performed on the flash memory module 120, and the number of valid pages of one or more blocks may be increased, and/or the number of valid pages of one or more blocks may be decreased.

In Step 306, the microprocessor 112 determines the group having the block(s) whose number of valid pages is changed, and the microprocessor 112 refers to the group minimum valid page array 520 get the minimum valid pages corresponding to the determined group. For example, if the number C_3 corresponding to the block B_3 is changed, the microprocessor 112 gets the number C_G1 from the group minimum valid page array 520.

In Step 308, the microprocessor 112 determines if the changed number of valid pages of the Step 304 is less than the minimum valid pages obtained in Step 306, if yes, the flow enters Step 310; if not, the flow enters Step 304.

In step 310, the microprocessor 120 updates the group minimum valid page array 520 by using the changed number of valid pages of the Step 304. For example, if the number C_G1 is equal to the number C_3 having the value “40”, and the number C_2 is updated to be “38” in Step 304, the microprocessor 112 updates the number C_G1 by using the number C_2.

In Step 312, it is determined if the flash memory microprocessor 112 receives a shutdown notification from the host device 50, if yes, the flow enters Step 314 and the flash memory controller 110 and the flash memory module 120 are powered off; if not, the flow enters Step 304.

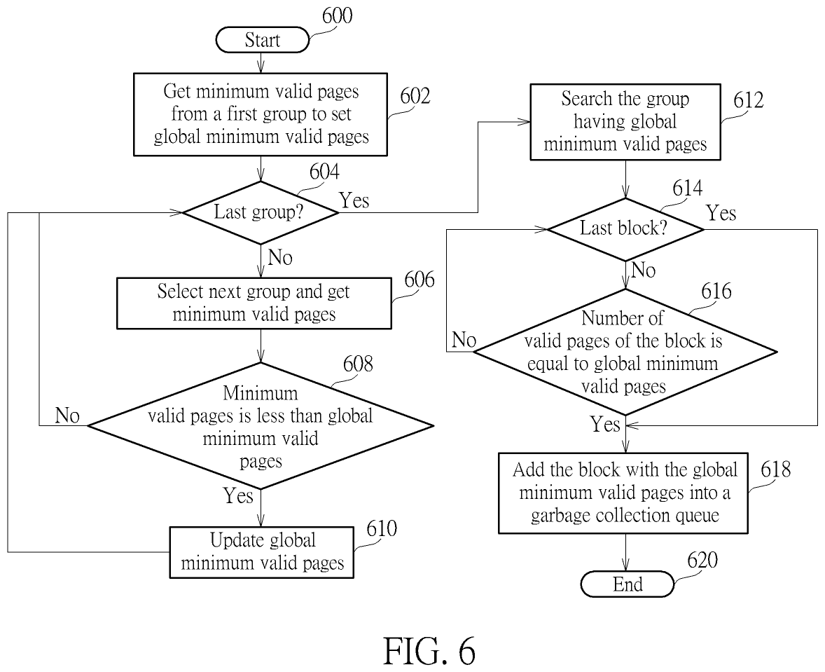

FIG. 6 is a flowchart of a method for managing the flash memory module 120 according to another embodiment of the present invention. In Step 600, the flow starts, and the group minimum valid page array 520 has been stored in the RAM 116 or the external DRAM. In Step 602, the microprocessor 112 refers to the group minimum valid page array 520 to select the first group. Taking FIG. 4 as an example, the group 410_1 is selected, and the minimum valid pages C_G1 serves as global minimum valid pages. In Step 604, the microprocessor 112 determines if the current group is a last group recorded in the group minimum valid page array 520, if yes, the flow enters Step 612; and if not, the flow enters Step 606. In Step 606, the microprocessor 112 selects the next group and gets the minimum valid pages of the current group, at this time, the group 410_2 is selected, so the minimum valid pages C_G2 is obtained. In Step 608, the microprocessor 112 determines if the minimum valid pages obtained in Step 608 is less than the global minimum valid page, if yes, the flow enters Step 610; and if not, the flow enters Step 604. In Step 610, the microprocessor 112 updates the global minimum valid pages by using the minimum valid pages obtained in Step 606. For example, if the global minimum valid pages is the minimum valid pages C_G1 , and the minimum valid pages C_G2 is less than the minimum valid pages C_G1, the global minimum valid pages becomes the minimum valid pages C_G2.

In Step 612, the microprocessor 112 sequentially searches the blocks within the group having the global minimum valid pages. In Step 614, the microprocessor 112 determines if the current block is a last block, if yes, the flow enters Step 618; and if not, the flow enters Step 616. In Step 616, the microprocessor 112 refers to the valid page table 510 to obtain the valid pages of the current block, and the microprocessor 112 determines if the valid pages of the current block is equal to the global minimum valid pages, if yes, the flow enters Step 618; and if not, the flow enters Step 614. In Step 618, the microprocessor 618 selects the block having the global minimum valid pages, and the microprocessor 618 adds this block into a garbage collection queue, wherein the blocks recorded in the garbage collection queue will be performed a garbage collection operation to move valid data into other blocks. In Step 620, the flow is finished.

In the embodiment shown in FIG. 3 and FIG. 6, by establishing the group minimum valid page array 520 and using group minimum valid page array 520 to find the block having the least valid pages, the microprocessor 112 can simply get the block having the least valid pages by only searching or scanning the blocks within one group, without searching blocks belonging to other groups. Therefore, the search time becomes shorter that may not degrade system efficiency.

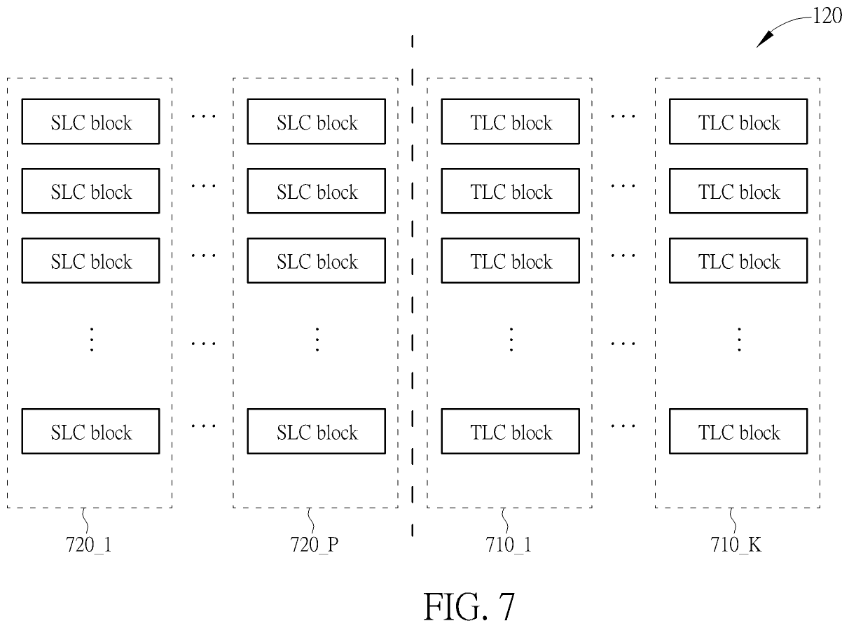

In one embodiment of the present invention, all of the blocks within the flash memory module 120 are needs to be grouped in the group minimum valid page array 520 as shown in FIG. 4 and FIG. 5, that is whether the block is a SLC block, a MLC block, a TLC block, a QLC block, a data block or a spare block, it needs to be grouped in the single group minimum valid page array 520. In another embodiment, two or more group minimum valid page arrays are established based on the types of the blocks. Taking FIG. 7 as an example, the flash memory module 120 has blocks with different types such as SLC blocks and TLC blocks, and the TLC blocks are grouped into several groups 710_1-710_K, and each group comprises a plurality of TLC blocks, wherein a first group minimum valid page array similar to the group minimum valid page array 520 shown in FIG. 5 is established based on the numbers of the valid pages of the TLC blocks. In addition, the SLC blocks are grouped into several groups 720_1-720_P, and each group comprises a plurality of SLC blocks, wherein a second group minimum valid page array similar to the group minimum valid page array 520 shown in FIG. 5 is established based on the numbers of the valid pages of the SLC blocks. In this embodiment, the garbage collections for the TLC blocks and the SLC blocks are separately executed, that is the microprocessor 112 determines the TLC block having the least valid pages based on the above first group minimum valid page array, and the microprocessor 112 determines the SLC block having the least valid pages based on the above second group minimum valid page array.

In another embodiment, only a portion of the blocks within the flash memory module 120 is grouped, and the other blocks are not grouped. Taking FIG. 7 as an example, the flash memory module 120 has blocks with different types such as SLC blocks and TLC blocks, and only the TLC blocks are grouped to generate the group minimum valid page array, and the SLC blocks are not grouped, that is the group minimum valid page array does not comprise the information of the SLC blocks.

Those skilled in the art will readily observe that numerous modifications and alterations of the device and method may be made while retaining the teachings of the invention. Accordingly, the above disclosure should be construed as limited only by the metes and bounds of the appended claims.

1. A method for managing a flash memory module, comprising:
grouping a plurality of blocks within the flash memory module into a plurality of groups, wherein each group comprises at least two blocks;
establishing a valid page table, wherein the valid page table records indexes of the plurality of blocks and corresponding numbers of valid pages, respectively, and each of the valid pages means that data within the valid page is not updated by new data written into another page;
establishing a group minimum valid page array based on the valid page table, wherein the group minimum valid page array records group indexes and corresponding minimum valid pages, respectively, wherein the minimum valid pages is obtained by selecting a minimum value among the numbers of valid pages of the blocks within the group;
referring to the group minimum valid page array to select a target group having a global minimum valid page, wherein the global minimum valid pages is obtained by selecting a minimum value among the minimum valid pages of the groups;
searching the at least two blocks within the target group, without searching the blocks within the other groups, to determine a target block having the global minimum valid pages; and
adding the target block into a garbage collection queue.

2. The method of claim 1, wherein the step of grouping the plurality of blocks within the flash memory module into the plurality of groups comprises:
if a number of the plurality of blocks is A, the blocks are divided into groups if \sqrt{A} is an integer; and
if \sqrt{A} is not an integer, the number of the groups is a smallest integer larger than \sqrt{A}.

3. The method of claim 2, wherein the number of blocks within one group is \sqrt{A} if \sqrt{A} is an integer; and and if \sqrt{A} is not an integer, the number of blocks within one group is a largest integer less than \sqrt{A}.

4. The method of claim 1, wherein the flash memory module comprises a first type of blocks and a second type of blocks, and the plurality of blocks that are grouped comprise only the first type of blocks, without comprising the second type of blocks.

5. The method of claim 4, wherein the first type of blocks are triple-level cell (TLC) blocks or quad-level cell (QLC) blocks, and the second type of blocks are single-level cell (SLC) blocks.

6. A flash memory controller, wherein the flash memory controller is coupled to a flash memory module, and the flash memory controller comprising:
a memory, for storing a program code;
a microprocessor, for executing the program code to access the flash memory module;
wherein the microprocessor groups a plurality of blocks within the flash memory module into a plurality of groups, wherein each group comprises at least two blocks; the microprocessor establishes a valid page table, wherein the valid page table records indexes of the plurality of blocks and corresponding numbers of valid pages, respectively, and each of the valid pages means that data within the valid page is not updated by new data written into another page; the microprocessor establishes a group minimum valid page array based on the valid page table, wherein the group minimum valid page array records group indexes and corresponding minimum valid pages, respectively, wherein the minimum valid pages is obtained by selecting a minimum value among the numbers of valid pages of the blocks within the group; the microprocessor refers to the group minimum valid page array to select a target group having a global minimum valid page, wherein the global minimum valid pages is obtained by selecting a minimum value among the minimum valid pages of the groups; the microprocessor searches the at least two blocks within the target group, without searching the blocks within the other groups, to determine a target block having the global minimum valid pages; and the microprocessor adds the target block into a garbage collection queue.

7. The flash memory controller of claim 6, wherein if a number of the plurality of blocks is A, the blocks are divided into \sqrt{A} groups if \sqrt{A} is an integer; and if \sqrt{A} is not an integer, the number of the groups is a smallest integer larger than \sqrt{A}.

8. The flash memory controller of claim 7, wherein the number of blocks within one group is \sqrt{A} if \sqrt{A} is an integer; and if \sqrt{A} is not an integer, the number of blocks within one group is a largest integer less than \sqrt{A}.

9. The flash memory controller of claim 6, wherein the flash memory module comprises a first type of blocks and a second type of blocks, and the plurality of blocks that are grouped comprise only the first type of blocks, without comprising the second type of blocks.

10. The flash memory controller of claim 9, wherein the first type of blocks are triple-level cell (TLC) blocks or quad-level cell (QLC) blocks, and the second type of blocks are single-level cell (SLC) blocks.

11. A memory device, comprising:
a flash memory module; and
a flash memory controller, configured to access the flash memory module;
wherein the flash memory controller groups a plurality of blocks within the flash memory module into a plurality of groups, wherein each group comprises at least two blocks; the flash memory controller establishes a valid page table, wherein the valid page table records indexes of the plurality of blocks and corresponding numbers of valid pages, respectively, and each of the valid pages means that data within the valid page is not updated by new data written into another page; the flash memory controller establishes a group minimum valid page array based on the valid page table, wherein the group minimum valid page array records group indexes and corresponding minimum valid pages, respectively, wherein the minimum valid pages is obtained by selecting a minimum value among the numbers of valid pages of the blocks within the group; the flash memory controller refers to the group minimum valid page array to select a target group having a global minimum valid page, wherein the global minimum valid pages is obtained by selecting a minimum value among the minimum valid pages of the groups; the flash memory controller searches the at least two blocks within the target group, without searching the blocks within the other groups, to determine a target block having the global minimum valid pages; and the flash memory controller adds the target block into a garbage collection queue.

12. The flash memory controller of claim 11, wherein if a number of the plurality of blocks is A, the blocks are divided into \sqrt{A} groups if \sqrt{A} is an integer; and if \sqrt{A} is not an integer, the number of the groups is a smallest integer larger than \sqrt{A}.

13. The flash memory controller of claim 12, wherein the number of blocks within one group is \sqrt{A} if \sqrt{A} is an integer; and if \sqrt{A} is not an integer, the number of blocks within one group is a largest integer less than \sqrt{A}.

14. The flash memory controller of claim 11, wherein the flash memory module comprises a first type of blocks and a second type of blocks, and the plurality of blocks that are grouped comprise only the first type of blocks, without comprising the second type of blocks.

15. The flash memory controller of claim 14, wherein the first type of blocks are triple-level cell (TLC) blocks or quad-level cell (QLC) blocks, and the second type of blocks are single-level cell (SLC) blocks.
